(19) United States
(12) Patent Application Publication
(10) Pub. No.: US 2026/0208458 A1
(43) Pub. Date: Jul. 23, 2026

(54) LAMINATING DEVICE AND METHOD FOR LAMINATING A FUNCTIONAL FOIL ONTO A SURFACE OF AN OPTICAL ELEMENT

(71) Applicant: Carl Zeiss Vision International GmbH, Aalen (DE)

(72) Inventors: Hao Pan, Guangzhou (CN); Jingye Liang, Guangzhou (CN); Cong Liang, Guangzhou (CN)

(73) Assignee: Carl Zeiss Vision International GmbH, Aalen (DE)

(21) Appl. No.: 19/571,869

(22) Filed: Mar. 19, 2026

Related U.S. Application Data
(63) Continuation of application No. PCT/EP2025/063729, filed on May 19, 2025.

(30) Foreign Application Priority Data
May 20, 2024 (WO) PCT/CN2024/094114

(51) Int. Cl. B29D 11/00; G02B 1/04

(52) U.S. Cl. CPC B29D 11/0073; B29D 11/00009; B29D 11/00951; G02B 1/04

(57) ABSTRACT

A laminating device laminates a functional foil onto a surface of an optical element. The laminating device includes a holding module, an optical element holder, and a thermal forming module. The holding module has a sleeve-shaped foil holder extending along a central longitudinal axis with an opening at an upper longitudinal end. The upper longitudinal end holds the functional foil and the optical element holder holds an optical element. The foil holder surrounds the optical element holder. The thermal forming module contains an air passage for providing an air flow with controlled temperature and pressure, which is arranged at a lower longitudinal end of the thermal forming module. The holding module and the thermal forming module are arranged along the central longitudinal axis such that the lower longitudinal end of the thermal forming module and the upper longitudinal end of the foil holder are facing each other.

### CROSS REFERENCE TO RELATED PATENT APPLICATIONS

This application is a continuation application of international patent application PCT/EP2025/063729, filed on May 19, 2025, and designating the U.S., which claims priority to International patent application PCT/CN2024/094114, filed on May 20, 2024, both of which are hereby incorporated by reference in their entireties.

### FIELD OF DISCLOSURE

The present disclosure relates to a laminating device and/or a method for laminating a functional foil onto a surface of an optical element, in particular a lens. The disclosure, thus, relates to the technical field of manufacturing and/or laminating of optical elements, in particular lenses (i.e., ophthalmic lenses, such as spectacle lenses).

### BACKGROUND

Manufacturing optical elements, in particular lenses (such as ophthalmic lenses), typically comprises applying one or more functional layers and/or coatings to the optical elements, which provide specific properties. For instance, the functional layers may be applied for anti-scratch and/or anti-reflection properties (i.e., improvements in scratch resistance and/or reduction in light reflection) of the optical elements. Currently, the functional layers are typically applied by complex, time-consuming, and costly processes. For example, hard coating is applied by dip-coating and anti-reflection coating is applied by physical vapor deposition. It is very useful to apply a functional foil onto a surface of an optical element such as optical lens by foil lamination, which reduces the production complexity, cost, and time.

Thermoforming is typically involved in the process of “laminating” a film onto the surface of an optical element. Accordingly, such a functional layer is typically heated and formed to achieve a desired curvature, and is then laminated onto a surface of the optical element, i.e., it is securely attached to the surface using, for instance, an adhesive. In the instance that the optical element is an ophthalmic lens, the functional layers are typically laminated onto the front surface of the lens.

Known approaches for applying functional layers onto optical elements have various drawbacks, in particular risks of low qualities to an insufficient degree, wherein air is trapped between the functional layer and the optical element, resulting in air bubbles. Further drawbacks include the process is not working for many types of geometry, especially the free-formed surface; as well as the high risk of wrinkling of the applied functional layers and risk of damaging the functional layers during the application process, resulting in further low laminating qualities.

WO 2021/170705 A1 describes a method of laminating a functional film onto an optical article, which comprises thermoforming the functional film so as to provide the functional film with a predetermined target curvature based on a curvature of a face of the optical article on which the functional film is to be applied, applying the functional film onto that face of the optical article, pressing the functional film against that face of the optical article so as to adhere the functional film to that face of the optical article, and heating the functional film at, at least one predetermined temperature after the applying, so that the functional film conforms to the curvature of that face of the optical article.

U.S. 2018/267222 A1 describes a method of making an optical lens molded to a first curved optical film, which includes providing a first optical film including alternating first and second polymeric layers, providing a thermoform tool having a curved surface, heating and conforming the first optical film to the curved surface to form a first curved optical film, and molding an optical lens onto the first curved optical film. However, this method is rather complex, as a thermoform tool with the curved surface corresponding to the desired curvature of the optical film is necessary, and manufacturing of the optical lens by molding and casting is performed, i.e., the optical lens is manufactured corresponding to the desired curvature and the curved optical film. This approach of the optical film touching the tool surface followed by stretching, followed by molding the optical lens onto the optical film and removing the thermoform tool after the molding process, may have negative effects on the resulting laminating quality. The described method does not allow a good control for avoiding air bubbles.

WO 2023/110887 A1 describes a method comprising providing an article having a non-zero radius of curvature and a thermoplastic film, moving relative to each other with the aim of bringing the thermoplastic film and the article into contact, applying heat to the thermoplastic film so that the heated thermoplastic film shrinks and takes the shape and curvature of the article, resulting in a thermoformed thermoplastic film, and optionally laminating the thermoformed thermoplastic film on a surface of an optical article by means of a layer of adhesive, the layer of adhesive being positioned between the optical article and the thermoplastic film. However, this method comprises laminating functional films by shrinkage which has a high chance to introduce air bubbles, and laminating thick foil by this method has a high chance to introduce wrinkles. Additionally, the thermal heating process does not allow a good temperature control, and the described method is limited to lamination on convex surfaces.

WO 2019/180251 A1 describes a method for producing a spectacle lens from a spectacle lens blank having an optically finished surface and a cylinder edge surface, in which a protective film is applied onto the optically finished surface. However, this method is limited on laminating a protective layer on a front surface of a spectacle lens, wherein the method involves vacuum only, providing a maximum pressure around 0.1 MPa.

WO 2006/105999 A1 describes an apparatus for conforming a functionalized flexible planar film on an optical lens. The functionalization process is a process of gluing, transferring, or molding of a functionalized flexible planar film onto an optical lens. However, the described approach separates the heating process and bending process, and does not have a good control on a desired curvature of the bent film, resulting in risks of decreased laminating qualities, such as wrinkles and air bubbles.

WO 2021/170704 A1 describes a thermoforming machine comprising a thermoforming chamber having at least one heated air inlet through which heated air flows into the thermoforming chamber at a controlled pressure. The air inlet cooperates with a heated air flow distribution regulator located in the thermoforming chamber and through which the heated air flows out of the thermoforming chamber at a predetermined temperature. The regulator comprises a heated air flow regulating mask receiving a heated air flow, having a plurality of flow restricting elements providing different air flow restrictions. However, the described approach focusses on the thermoforming of the film, wherein the precision in the desired curvature of the film is improved by reducing the temperature gradients in the film during thermoforming, but the approach does not concern the laminating process of the film onto a face of an optical article and in particular the potential risks.

WO 2020/074599 A1 describes a lamination machine comprising a film support for receiving a functional film to be laminated, an article support configured to receive and position the optical article in a predetermined orientation, and an actuating member configured to move the film support and the article support toward each other for laminating at a predetermined pressure the functional film received in the film support onto the optical article received within the article support. However, the described approach focusses on the laminating process, wherein the film is laminated onto the optical article with a predetermined pressure, but the approach does not explicitly concern the thermoforming process of the film and especially not the potential risks. Additionally, aligning the functional film axis to the lens axis is necessary, resulting in a more complex system.

U.S. 2016/0052201 A1 describes a method for producing a decorative lens capable of effectively suppressing deformation of the lens in laminating a film material to the lens even when lenses vary widely in shape, in which support jigs or the like for suppressing deformation of lenses need not be provided for respective lenses having different shapes.

### SUMMARY

In view of this related art, the object of the present disclosure is to disclose a device and/or a method, each of which is suitable for enriching the related art. For instance, in view of WO 2021/170705 A1 as closest related art, the object may relate to providing a laminating device and method resulting in higher laminating qualities between a functional foil and an optical element comprising concave, convex, or free-formed surface, such as avoiding air bubbles trapped between a laminated functional foil and an optical element.

The object is achieved by laminating device and a method for laminating a functional foil onto a surface of an optical element, as disclosed herein. Exemplary embodiments are described in the description below.

In one aspect, a laminating device for laminating a functional foil onto a (e.g., free form and/or curved) surface of an optical element is provided.

The laminating device comprises a holding module. The holding module comprises a sleeve-shaped foil holder extending along a central longitudinal axis and having an opening at an upper longitudinal end of the foil holder. The upper longitudinal end (of the foil holder) is configured to hold the functional foil. The holding module comprises an optical element holder for holding the optical element. The foil holder surrounds the optical element holder.

The laminating device comprises a thermal forming module which comprises at least one air passage for providing an (e.g., homogeneous) air flow with a controlled temperature and pressure. The at least one air passage is arranged at a lower longitudinal end of the thermal forming module.

The holding module and the thermal forming module are arranged along the central longitudinal axis such that the lower longitudinal end of the thermal forming module and the upper longitudinal end of the foil holder are facing each other. The thermal forming module is movable along the central longitudinal axis for adjusting a distance between the lower longitudinal end of the thermal forming module and the upper longitudinal end of the foil holder.

The foil holder comprises at least one vacuum passage. The laminating device comprises a vacuum pump connected to the at least one vacuum passage for applying a vacuum inside the foil holder.

The optical element holder is movable along the central longitudinal axis at an adjustable velocity inside the foil holder.

In another aspect, a method for laminating a functional foil onto a surface of an optical element (e.g., by using the laminating device) is provided.

The method comprises placing the optical element on an optical element holder of a laminating device. The method comprises placing the functional foil on a foil holder of the laminating device. The functional foil and the optical element are placed such that the optical element is arranged at a distance below the functional foil with the surface of the optical element facing the functional foil.

The method comprises providing an air flow with a controlled temperature and pressure above the placed functional foil (e.g., by a thermal forming module of the laminating device).

The method comprises applying a vacuum below the placed functional foil (and/or between the placed functional foil and the placed optical element) simultaneously to providing the air flow.

The method comprises arranging the functional foil onto the surface of the optical element while the air flow is provided and the vacuum is applied.

The method further comprises adjusting and/or temporarily increasing the controlled pressure of the air flow before the functional foil is arranged onto the surface of the optical element, until the functional foil is stretched into a spherical shape with a radius that is smaller than a radius of a center area of the optical element.

Furthermore, a method being suitable for manufacturing a spectacle lens is provided.

The method comprises laminating a functional foil onto a surface of an optical element using a method according to the disclosure. The optical element is the spectacle lens to be manufactured or one of a lens blank, a semi-finished lens blank, or an uncut finished lens from which the spectacle lens is manufactured.

In an operating state of the laminating device (e.g., when the laminating device is in use), the functional foil is held or positioned at the upper longitudinal end of the foil holder, wherein the opening at the upper longitudinal end of the foil holder is closed by the functional foil. A center of the functional foil may be arranged above the opening (and/or arranged for closing the opening). The optical element is held by the optical element holder, inside the foil holder (i.e., surrounded by the foil holder), wherein the optical element is arranged below functional foil (and, thus, below the opening at the upper longitudinal end of the foil holder).

Accordingly, the foil holder is configured to hold the functional foil, and the optical element holder is configured to hold the optical element such that the optical element is arranged at a distance below the functional foil with the surface of the optical element facing the functional foil. The foil holder may be configured to hold the functional foil by the functional foil being placed on (e.g., the upper longitudinal end of) the foil holder. The optical element holder may be configured to hold the optical element by the optical element being placed on (e.g., the upper longitudinal end of) the optical element holder.

By providing the air flow with the controlled temperature and pressure at the at least one air passage and therefore at the lower longitudinal end of the thermal forming module, the air flow is provided above the functional foil in the operating state of the laminating device, e.g., between the lower longitudinal end of the thermal forming module and the functional foil. The air flow may be (e.g., homogeneously) directed towards the opening at the upper longitudinal end of the foil holder and, thus, directed towards the functional foil. The functional foil is stretched and/or bent into a spherical shape, e.g., to achieve a desired curvature of the functional foil. In particular, the functional foil is stretched and/or bent through the opening at the upper longitudinal end of the foil holder.

By applying the vacuum inside the foil holder, the vacuum is applied below the functional foil, and in particular between the functional foil and the optical element, in the operating state of the laminating device.

Accordingly, by providing the heated air flow and (e.g., simultaneously) applying the vacuum, the functional foil can be formed to a desired curvature, which is also known as thermoforming.

Vacuum is considered a negative air pressure, i.e., a pressure below the atmospheric pressure, and is not limited to the extreme option of no air (i.e., the removal of all air) inside the foil holder. The vacuum is applied by pumping (and/or sucking) air from the inside of the foil holder through to the at least one vacuum passage via the vacuum pump.

The optical element may be a spectacle lens. The spectacle lens may be destined for sunglasses and/or (related)refractive eyewear, e.g., as specified in section 3 of ISO 12312-1: 2013(E). The optical element may be a lens blank. The optical element may be a semi-finished lens blanks, e.g., as specified in section 4 of ISO 10322-2:2016(E). The optical element may be an uncut finished lens, e.g., as specified in section 4 of ISO 8980-1: 2017(E), which may be referred to as finished spectacle lens product. The optical element may have dimensions corresponding to final dimensions of the (final) optical element. In other words, the optical element may be pre-manufactured. The laminating of the functional foil may be performed at the end of a manufacturing process of the optical element when the optical element is ready for use (e.g., is ready to be worn by a user, in case that the optical element is an ophthalmic lens) or at least the surface of the optical element is finished (e.g., cutting and polishing of the surface has been performed to achieve a desired form of the surface).

A lens blank may relate to an unprocessed precursor of a spectacle lens, such as a lens blank having an unprocessed front surface and an unprocessed back surface. The lens blank may be provided in a molding process. The lens blank may, however, also relate to a partly processed precursor of a spectacle lens. For instance, the lens blank may have a front surface which is partly or fully processed, and which may be covered with a protective foil or coating. As generally understood and defined in section 3.8.1 of ISO 13666:2019 (E), a lens blank may be a piece of optical material with one optically finished surface for the making of a lens.

The optical element may be a spectacle lens blank, a semi-finished spectacle lens product or a finished spectacle lens product and may in particular meet requirements specified in EN ISO 13666:2012. Throughout the disclosure, the term “substrate” may in general relate to a spectacle lens, a lens blank, a semi-finished spectacle lens product and/or a finished spectacle lens product unless explicitly specified otherwise.

As generally understood and defined in section 3.5.2 of ISO 13666:2019 (E), a spectacle lens may be an ophthalmic lens according to section 3.5.1 of ISO 13666:2019 (E) worn in front of, but not in contact with, the eyeball.

The surface of the optical element may be concave, convex, or free-form. In other words, the laminating process performed by the above-described laminating device and the above-described method is not limited to specific surface forms of surfaces to be laminated. The surface may be a front surface or a back surface of a spectacle lens or a spectacle lens blank or a semi-finished spectacle lens product or a finished spectacle lens product.

As generally understood and defined in section 3.2.13 of ISO 13666:2019 (E), the front surface of a spectacle lens or spectacle lens blank is the surface of the lens or lens blank intended to be fitted away from the eye.

As generally understood and defined in section 3.2.14 of ISO 13666:2019 (E), the back surface of a spectacle lens or spectacle lens blank is the surface of the lens or lens blank intended to be fitted nearer to the eye.

The functional foil may be a foil and/or film comprising a nanostructure for providing one or more functions, e.g., anti-scratch, anti-reflection and/or clean-coat; i.e., a coating which may provide dirt-repellant properties. Other functions are possible, such as light polarization, wavelength filtering defined for specific wavelength ranges, anti-smudge properties, anti-fog properties, anti-UV, tint, mirror, self-healing, self-cleaning, and/or antistatic properties.

“Sleeve-shaped” refers to the foil holder, which is at least circumferentially surrounding the optical element holder. Accordingly, the foil holder comprises a foil holder cavity (e.g., formed by the sleeve shape), wherein the optical element holder is arranged inside the foil holder, namely inside the foil holder cavity. Hence, the foil holder surrounding the optical element holder corresponds to the optical element holder being arranged inside the foil holder and/or configured to hold the optical element inside the optical element holder.

The above-described laminating device and method provides the advantage of, among other things, an improved device and method for providing a reliable process to laminate functional foils on (e.g., free-designed) surfaces of optical elements, resulting in reduced processing cycle time, cost, and complexity.

By making use of providing the air flow with controlled temperature(s) and pressure(s) above the functional foil, and applying a vacuum below the functional foil during the laminating process, in particular simultaneously, high laminating qualities can be achieved, wherein air bubbles trapped by the laminated functional foil and wrinkles of the laminated functional foil can be avoided. In particular, due to the application of the vacuum, air traps between the functional foil and the optical element can be prevented, wherein the vacuum also contributes to a uniform bending force to the functional foil when the functional foil is bent to a desired curvature before arranging the functional foil onto the surface of the optical element. Accordingly, the present disclosure also provides an optimization or at least an improvement of the adherence and/or shape of the functional film to be applied.

Additionally, the laminating device provides a non-contact thermoforming process, wherein any bending and/or stretching of the functional foil is achieved exclusively by the provided air flow and the applied vacuum, without the necessity of any additional thermoforming tools. Accordingly, the laminating device is less complex, wherein the lack of thermoforming tools which have to be applied and then removed from the functional foil reduce risks of damaging the functional foil during the thermoforming and laminating process.

In comparison to WO 2021/170705 A1, using the above-described laminating device and methods results in higher laminating qualities, in particular wherein air bubbles are avoided due to the approach of simultaneously providing the air flow and applying the vacuum, wherein only a pressurized air is applied in WO 2021/170705 A1. Additionally, due to the functional foil held by the foil holder (e.g., by clamping the functional foil between the thermal forming module and the foil holder), the functional foil is fixed to avoid moving, thereby contributing to the functional foil’s bending and stretch, wherein no heavy stretching of the functional foil is necessary, contrary to the method of WO 2021/170705 A1. This further increases the laminating qualities, such as avoiding wrinkles.

In comparison to U.S. 2018/267222 A1, the laminating device is much less complex, as no thermoforming tool for forming the functional foil is used, but the functional foil is formed exclusively by providing the air flow and employing the vacuum to form the functional foil to the desired curvature. Additionally, no molding and casting of the optical element is necessary, as a pre-manufactured optical element is used, wherein the functional foil can be laminated onto any free-form surface. Overall, the approach using the above-described laminating device and method results in higher laminating qualities, in particular wherein damages of the functional foil and air bubbles trapped by the functional foil are avoided due to the non-contact approach for forming the functional foil and laminating the functional foil onto the optical element, and due the approach of simultaneously providing the air flow and applying the vacuum.

Additionally, U.S. 2018/267222 A1 concerns a rather different application scenario, which mainly concerns making film stacks in display or imaging system, wherein the above-described laminating device is configured to laminating functional foil onto single optical elements, in particular lenses.

In comparison to WO 2023/110887 A1 which describes laminating a functional film by shrinkage of the film with no or only small pressure on the film to avoid stretch or bend film during lamination process, higher lamination qualities by the above-described approach are achieved by avoiding air bubbles and wrinkles due to the approach of simultaneously providing the air flow and applying the vacuum, wherein the laminating device provides better temperature control by providing the air flow with the controlled temperature and pressure. Additionally, the method of WO 2023/110887 A1 is a contact approach, wherein the technique of the present disclosure is a non-contact approach using the provided air flow and the applied vacuum, thereby reducing the risk of damaging the functional foil structure. Furthermore, the above-described laminating device can be used for laminating any free-form surface, not only convex surfaces as described in WO 2023/110887 A1.

In comparison to WO 2019/180251 A1, higher lamination qualities are achieved by avoiding air bubbles and wrinkles due to the approach of simultaneously providing the air flow and applying the vacuum, wherein the method of WO 2019/180251 A1 only involves a vacuum. Additionally, the above-described laminating device and method are not limited to laminating specific optical elements and specific surface forms, wherein the method of WO 2019/180251 A1 is limited to laminating a protective layer on a front surface of a spectacle lens.

In comparison to WO 2006/105999 A1, heating and force due to the provided air flow is maintained at all times during the film bending and lamination process, thereby providing good laminating qualities. With the simultaneous application of the vacuum, the laminating qualities are further increased, in particular by avoiding wrinkles and air bubbles. Additionally, contrary to the method of WO 2006/105999 A1, the technique of the present disclosure is a non-contact approach using the provided air flow and the applied vacuum, thereby reducing the risk of damaging the functional foil structure.

In comparison to WO 2021/170704 A1, higher lamination qualities are achieved by avoiding air bubbles and wrinkles due to the approach of simultaneously providing the air flow and applying the vacuum, wherein the method of WO 2021/170704 A1 only describes an air flow towards the film with a controlled temperature and a regulated distribution during the thermoforming process of the film.

In comparison to WO 2020/074599 A1, higher lamination qualities are achieved by avoiding air bubbles and wrinkles due to the approach of simultaneously providing the air flow and applying the vacuum, wherein the method of WO 2020/074599 A1 only describes the laminating process, wherein the film is laminated onto the optical article with a predetermined pressure. Furthermore, no additional alignment of the functional foil axis to the optical element axis is necessary, resulting in a less complex system of the above-described laminating device.

Possible further implementations of the laminating device and/or the method described herein are explained in detail below.

The laminating device may be configured to provide the air flow directed downwards and/or directed towards the opening at the upper longitudinal end of the foil holder. Advantageously, the air flow is directed directly towards a portion of the functional foil to be laminated onto the surface of the optical element, wherein the portion is arranged above the opening at the upper longitudinal end of the foil holder in an operating state of the laminating device. Accordingly, the non-contact thermoforming process of the portion of the functional foil can be performed by controlling the provided air flow to achieve the desired curvature, before the functional foil is laminated onto the optical element.

The laminating device may be configured to bend and/or stretch the functional foil to a (desired) spherical shape and/or curvature (exclusively) by providing the air flow and applying the vacuum, e.g., wherein the controlled temperature and/or pressure may be varied (and/or adjusted). Advantageously, the laminating device provides a non-contact thermoforming process, wherein the thermoforming of the functional foil is achieved exclusively by the provided air flow and the applied vacuum, without the necessity of any additional thermoforming tools, in particular without any tool which has to be brought into direct contact with the functional foil. Accordingly, risks of damaging the functional foil during the thermoforming and laminating process is greatly reduced.

The laminating device may comprise a control unit for controlling the thermal forming module and the vacuum pump. In an operating state of the laminating device, the control unit may be configured to control the thermal forming module to provide the air flow with the control temperature and pressure, and to simultaneously (i.e., simultaneously to providing the air flow) activate the vacuum pump and/or control the vacuum pump to apply a vacuum inside the foil holder. Advantageously, the laminating device is configured to automatically control the optimized settings for achieving the desired curvature of the functional foil, thereby achieving an increased accuracy of the thermoforming process and high laminating qualities of the functional foil laminated onto the optical element without damages, wrinkles and trapped air bubbles.

The laminating device may comprise a (first) moving unit for moving the thermal forming module. The (first) moving module may comprise an actuator and/or motor. The control unit may be configured to control the (first) moving unit for moving the thermal forming module with an adjustable velocity, e.g., a constant velocity. Advantageously, the thermal forming module can be moved in a controllable, non-manual manner, such that the thermal forming module can be arranged at a desired position (e.g., for arranging the at least one air passage of the thermal forming module at a desired position with respect to the placed functional foil for providing the air flow and/or for fixing the functional foil at the intended position by clamping the functional foil between the thermal forming module and the foil holder) with high accuracy.

An upper longitudinal end of the optical element holder may be configured to hold the optical element such that the surface of the optical element is arranged averted from the upper longitudinal end of the optical element and/or facing the opening at the upper longitudinal end of the foil holder. Advantageously, the surface of the optical element (held by the optical element holder) is oriented towards the functional foil (held by the foil holder) in an operating state of the laminating device such that, e.g., no changes of orientation of the optical element is necessary during the method. In other words, the optical element is placed stationary on the optical element holder at all times during the method, i.e., the laminating process.

The upper longitudinal end of the optical element holder (e.g., a shape of the upper longitudinal end) may be at least partially adapted to a shape (and/or curvature) of the optical element, e.g., a second surface of the optical element arranged opposite to the surface of the optical element. A diameter and/or size of the opening may be larger than a diameter and/or size of the upper longitudinal end of the optical element holder (and/or the optical element). Advantageously the optical element can be sufficiently held and secured by placing the optical element on the optical element holder without the necessity of any additional fastening elements. Additionally, due to the adapted form of the optical element holder, the optical element is oriented and aligned in a desired position for performing the method, in particular the laminating process, such that no changing of the orientation and alignment of the optical element is necessary during the method.

The optical element holder may be movable along the central longitudinal axis at an adjustable velocity inside the foil holder. The laminating device may comprise a (second) moving unit for moving the optical element holder. The (second) moving module may comprise an actuator and/or motor. The control unit may be configured to control the (second) moving unit for moving the optical element holder with the adjustable velocity, e.g., a constant velocity. Advantageously, the optical element can be moved upwards with the controlled velocity, thereby benefitting from a constant pressure applied on the functional foil when the moving optical element presses against the functional foil in order to arrange the functional foil onto the surface of the optical element.

The foil holder may be stationary and/or not movable. In other words, the functional foil may be arranged onto the surface of the optical element by only moving the optical element (i.e., the optical element holder). Advantageously, a simple solution for arranging the functional foil onto the surface of the optical element is provided, thereby limiting the number of technical components, in particular movable components, resulting in an arrangement which is less prone to technical difficulties such as wear. In addition, risks of damaging the functional foil during the thermoforming and laminating process are limited by refraining from any additional movements of the functional foil besides the stretching of the functional for during the thermoforming.

The upper longitudinal end of the foil holder may be configured to hold the functional foil such that a portion of the functional foil to be laminated onto the surface of the optical element is arranged above the opening and/or the opening is (completely) closed by the functional foil. The functional foil may be larger than the opening. Advantageously, the portion of the functional foil to be laminated onto the surface of the optical element is directly accessible and, thus, can be directly and immediately arranged onto the surface after the desired curvature has been achieved during the thermoforming. Hence, it is not necessary to move the functional foil, thereby reducing any risks of damaging the functional foil or any alterations its achieved curvature.

The thermal forming module may be movable along the central longitudinal axis for clamping the functional foil between the lower longitudinal end of the thermal forming module and the upper longitudinal end of the foil holder in an operating state of the laminating device. Advantageously, no additional clamping components are necessary for fixing the functional foil at an intended position. Additionally, the movability of the thermal forming module provides two technical functions at the same time, namely arranging the at least one air passage of the thermal forming module at the desired position with respect to the placed functional foil for providing the air flow and fixing the functional foil at the intended position, resulting in more accurate thermoforming and laminating process.

The thermal forming module may comprise a thermal chamber which is fluidly connected to the at least one air passage. The thermal forming module may comprise at least one air inlet for providing air to the thermal chamber. The thermal forming module may comprise a heating element arranged inside the thermal chamber. The heating element may be configured to heat the air provided by the at least one air inlet to reach the controlled temperature. The control unit may be configured to control the heating element.

The thermal forming module may further comprise a thermocouple arranged inside the thermal chamber. The thermocouple may be configured to measure the temperature of the air heated by the heating element, e.g., for determining when the air has reached the controlled temperature. The control unit may be configured to receive a signal (e.g., a voltage) from the thermocouple, wherein the signal may depend on the temperature of the air inside the thermal chamber. Advantageously, the thermal forming module is controllable to provide the air flow with the controlled temperature with high accuracy, since the temperature of the air can be monitored during the heating process and, e.g., the heating element may be controlled depending on the temperature measured by the thermocouple.

The thermal forming module may further comprise a pressure unit (and/or pressure regulator) for providing the air flow with the controlled pressure. The pressure unit may be arranged inside the thermal chamber and/or the at least one air passage. Alternatively, or in addition, it is possible that the laminating device may comprise an air pressure unit (e.g., an air pump) for providing air (e.g., the air flow) with the controlled pressure. The air pressure unit may be fluidly connected to the thermal forming module¸ e.g., the at least one air inlet for providing the air (e.g., the air flow) with the controlled pressure into the thermal chamber. The control unit may be configured to control the pressure unit and/or the air pressure unit. The pressure unit and/or air pressure unit may comprise, e.g., an air compressor and/or fan. Advantageously, a pressure unit is provided, e.g., as part of the thermal forming module, which is controllable to provide the air flow with the controlled desired pressure.

The foil holder may comprise a window for observing the optical element and/or the functional foil (e.g., while the method and/or the laminating process is performed). The window may be arranged adjacent to the upper longitudinal end of the foil holder. Advantageously, the method, i.e., the thermoforming and laminating process, can be observed by a user who may intervene in case of any irregularities or problems, e.g., by adjusting the temperature and pressure of the provided air flow or by interrupting or stopping the thermoforming or eliminating process.

The thermal forming module may further comprise a cooling unit for providing a controlled cooling process and/or for cooling the air flow to reach the controlled temperature. The control unit may be configured to control the cooling unit. Advantageously, the thermal formal module may control the temperature of the provided air flow in a more accurate and faster manner by actively cooling the air, e.g., in case that the air has been heated to a higher temperature as desired and/or at the end of the thermoforming and laminating process, when the controlled temperature may be lowered to a setting temperature of the functional foil.

The optical element holder may be rod-shaped and extending along the central longitudinal axis. Advantageously, a simple design of the optical element holder (movable along the central longitudinal axis) is provided, wherein the number of technical components, in particular movable components, is limited, resulting in an arrangement which is less prone to technical difficulties such as wear.

The holding module may comprise a guiding element for guiding the optical element holder (inside the foil holder and/or surrounded by the foil holder). The guiding element may be sleeved-shaped and extending along the central longitudinal axis, e.g., with open longitudinal ends. The optical element holder may be partially arranged (and/or moveably arranged) inside the guiding element. Advantageously, the guiding element is a simple and easy to implement option for holding and guiding the optical element holder movable transversely along one axis, namely the central longitudinal axis.

The foil holder may have an air-tight lower longitudinal end. The optical element holder and/or the guiding element may extend through the lower longitudinal end of the foil holder in an air-tight manner. Advantageously, vacuum can be applied inside the foil holder in an effective manner though the at least one vacuum passage, wherein the possibilities for entering air into the foil holder are eliminated or at least limited by providing the air-tight lower longitudinal end. In particular, the foil holder may only comprise one opening, namely the opening at the upper longitudinal end, which is closed by the functional foil in an operating state of the laminating device, i.e., when the vacuum is to be applied.

The at least one air passage may be positioned directly above the opening at the upper longitudinal end of the foil holder. The at least one air passage may comprise multiple air passages for providing a uniform heat distribution and/or uniform pressure distribution. Advantageously, the air flow is directed directly towards a portion of the functional foil to be laminated onto the surface of the optical element, wherein the portion is arranged above the opening at the upper longitudinal end of the foil holder in an operating state of the laminating device. Additionally, the uniform heat distribution and/or uniform pressure distribution provides a more effective thermoforming by homogenously stretching the functional foil to achieve the desired curvature, wherein the functional foil is heated and/or stretched uniformly to minimize any additional stresses to the functional foil which may result in damages such as tears during the thermoforming.

The air flow may be directed downwards (e.g., along the central longitudinal axis) and/or directed towards the functional foil (and/or the opening at the upper longitudinal end of the foil holder). The air flow may be homogeneous. The air flow may comprise a uniform heat distribution and/or uniform pressure distribution. The air flow may bend and/or stretch the functional foil homogenously in various directions. Advantageously, as stated above, the air flow is directed directly towards a portion of the functional foil to be laminated onto the surface of the optical element, thereby, providing the non-contact thermoforming process of the portion of the functional foil to achieve the desired curvature. The homogeneous air flow (regarding the heat and/or pressure distribution) provides a more effective thermoforming by homogenously stretching the functional foil to achieve the desired curvature, wherein the functional foil is heated and/or stretched uniformly to minimize any additional stresses to the functional foil which may result in damages such as tears during the thermoforming.

The method may comprise bending and/or stretching the functional foil to a (desired) spherical shape and/or curvature (exclusively) by providing the air flow and applying the vacuum, before the functional foil is arranged onto the surface, e.g., wherein the controlled temperature and/or pressure may be varied (and/or adjusted). The functional foil may be bent and/or stretched to the (desired) spherical shape and/or curvature without additional tools (and/or in a non-contact approach). The functional foil may be bent and/or stretched through the opening at the upper longitudinal end of the foil holder. Advantageously, the non-contact thermoforming process is provided without the necessity of any additional thermoforming tools, wherein the thermoforming is performed and the desired curvature is achieved by the air flow with the controlled and adjustable temperature and pressure. By arranging the thermal forming module above the functional foil and directing the air flow towards the portion of the functional foil to be laminated onto the surface of the optical element, wherein the portion is arranged above the opening at the upper longitudinal end of the foil holder, the functional foil can advantageously stretch through the opening to achieve the desired curvature.

The (desired) spherical shape and/or curvature may be independent from and/or correspond to a curvature of the surface of the optical element. Advantageously, it has been found that the functional foil does not have to be thermoformed to the exact form, i. e., curvature, of the surface of the optical element before arranging the functional foil onto the surface. The thermoforming is started before arranging the functional foil onto the surface in order to change the material of the functional foil from a rigid to a soft, stretchable state, thereby permitting stretching of the functional foil. The thermoforming may be continued while the functional foil is arranged onto this surface of the optical element by continuously providing the air flow above the functional foil and the vacuum below the functional foil such that the form (and/or curvature) of the functional foil can adapt to the form (and/or curvature) of the surface. The desired curvature is advantageous, e.g., during the laminating process, i. e., when the functional foil is arranged onto the surface of the optical element, wherein the arranging is performed gradually rather than arranging the functional foil onto the entire surface at the same time. For instance, in a first stage, the optical element may be moved until the surface of the optical element (in particular a central area of the surface) touches a center of the curved functional foil (i. e., the area of the functional foil arranged closest to the surface of the optical element after the desired curvature of the functional foil has been achieved). By continuously moving the optical element, the gradual arranging is continued, e.g., until the entire surface is covered by the functional foil. Due to this gradual laminating process, higher laminating qualities are achieved, e.g., wherein air between the functional foil and the surface can escape before being trapped in air bubbles.

The functional foil may be (only, for instance) arranged onto the surface of the optical element by moving the optical element (e.g., upwards) towards the functional foil at an adjustable velocity (e.g., by moving the optical element holder). The optical element may be moved in multiple stages, wherein, in a first stage, the optical element may be moved until a central area of the optical element touches the functional foil. For instance, the optical element may be moved, until the surface of the optical element is positioned at or inside the opening at the upper longitudinal end of the foil holder. Advantageously, the optical element can be moved upwards with a controlled velocity such that a controlled pressure is applied on the functional foil when the moving optical element presses against the functional foil in order to arrange the functional foil onto the surface of the optical element. Hence, a simple solution of the laminating process is provided, wherein laminating the functional foil onto the optical element is realized by simply moving the optical element without the necessity of any additional components or tools.

The functional foil may comprise a pressure sensitive adhesive and/or optical glue coated on one side of the functional foil. The functional foil may not comprise a pressure sensitive adhesive and/or optical glue in the case of a pressure sensitive adhesive and/or optical glue is pre-coated on one side of optical element. The functional foil may be placed on the foil holder with the side of the functional foil facing the surface of the optical element. The pressure sensitive adhesive may be configured to be pressed onto the surface of the optical element so as to maintain the functional foil on the surface. Alternatively, or in addition, the optical element may comprise a pressure sensitive adhesive and/or an optical glue coated on the surface of the optical element. Advantageously, the pressure sensitive adhesive and/or optical glue provides a sufficient adhesive bond between the functional foil and the surface of the optical element. Mechanical pressure may be applied to press the functional foil onto the optical element in order to activate a pressure sensitive glue. Alternatively or additionally, an optical glue, i.e., an optically activatable glue, may be provided between the functional foil and the optical element and exposed to optical radiation, optionally ultraviolet radiation, in order to activate the optically activatable glue. The functional foil and/or the optical element may be at least partially transparent for the irradiated ultraviolet radiation. The ultraviolet radiation may, thus, be irradiated through the functional foil and/or through the optical element onto the optical glue. Alternatively or additionally, the functional foil and/or the optical element may be exposed to heat in order to activate and/or harden a glue provided between the functional foil and the optical element. The heat may be provided by heating the optical element and/or the functional foil and/or the ambient air surrounding the optical element and/or the functional foil. Alternatively or additionally, the heat may be provided by optical radiation, such as infrared radiation being at least partially absorbed by the optical element and/or the functional foil. The terms “glue” and “adhesive” are used as synonyms throughout the disclosure. One or more of these techniques for activating and/or hardening the glue may bond the adhesive and/or glue with the surface of the optical element (in case that the adhesive and/or glue is provided as a coating of the functional foil) and/or with the functional foil (in case that the adhesive and/or glue is provided as a coating of the surface of the optical element). By providing the pressure sensitive adhesive and/or an optical glue as a coating of the functional foil and/or the optical element, no method step (or additional components of the laminating device) for applying the adhesive and/or glue is necessary, thereby simplifying the laminating process.

The functional foil may be arranged on a release film. The release film may be arranged at a second side of the functional foil opposite to the pressure sensitive adhesive. The functional foil may be placed on the foil holder with the second side of the functional foil arranged averted from the optical element. The release film may be configured to be removed after the functional foil is laminated onto the surface of the optical element. Advantageously, the release film provides a more secure possibility for handling the functional foil, in particular when it is placed on the foil holder, as the release film can be grabbed and it is not necessary to directly touch the functional foil, thereby reducing any risks of damages to the functional foil.

The method may comprise clamping the placed functional foil between the foil holder and a thermal forming module of the laminating device by moving the thermal forming module towards the foil holder. Advantageously, as stated above, the movability of the thermal forming module provides two technical functions at the same time, namely arranging the at least one air passage of the thermal forming module at the desired position with respect to the placed functional foil for providing the air flow and fixing the functional foil at the intended position without the necessity of any additional clamping components, thereby resulting in a more accurate thermoforming and laminating process.

The controlled temperature may correspond to a glass transition temperature of the functional foil (e.g., a material of the functional foil) or higher. Advantageously, the functional foil is heated until to the glass transition temperature is reached, at which stretching of the functional foil is permitted, i.e., the material of the functional foil has changed from a rigid to a soft, stretchable state.

The method may comprise adjusting and/or temporarily increasing the controlled pressure of the air flow before the functional foil is arranged onto the surface of the optical element, until the functional foil is stretched into a spherical shape with a radius that is (e.g., 40mm to 80mm) smaller than a radius of a center area of the optical element. The radius of the spherical shape of the stretched functional foil may relate to a radius of curvature of the spherical shape. The radius of the center area of the optical element may relate to a radius of curvature of a center area of the surface of the optical element facing the functional foil. The radius of the spherical shape of the functional foil may be in a range from 40 mm to 80 mm. Advantageously, as stated above, it has been found that the functional foil does not have to be thermoformed to the exact form, i. e., curvature, of the surface of the optical element before arranging the functional foil onto the surface, but the thermoforming may be continued while the functional foil is arranged onto this surface of the optical element such that the form (and/or curvature) of the functional foil can adapt to the form (and/or curvature) of the surface. As further stated above, the laminating process, i.e., the arranging of the functional foil onto the surface of the optical element, may be performed gradually, wherein in a first stage, the optical element may be moved until the surface of the optical element (in particular a central area of the surface) touches a center of the curved functional foil (i. e., the area of the functional foil arranged closest to the surface of the optical element after the desired curvature of the functional foil has been achieved). It has been found that even higher laminating qualities can be achieved by the gradual laminating process if the spherical shape of the curved functional foil has a smaller radius than the center area of the surface.

The method may comprise reducing the controlled temperature to a setting temperature of the functional foil (e.g., a material of the functional foil) after the functional foil is arranged onto the surface of the optical element. Advantageously, the thermoforming process can be ended in a controlled manner in order to, e.g., reduce any additional stresses to the functional foil, until the setting temperature is reached, at which the functional foil is cooled off to the finished shape without permitting any further stretching. Accordingly, the control temperature may be reduced after the arrangement of the functional foil onto the surface in order to allow further stretching (i.e., thermoforming) of the functional foil during the laminating process, thereby, e.g., allowing that the form of the functional foil adapts to the form of the surface of the optical element and in order to achieve higher laminating qualities.

The method may comprise setting the controlled pressure to the atmospheric pressure and/or stopping the control of the pressure of the air flow after the functional foil is arranged on the surface of the optical element. Advantageously, the method can be ended in a controlled manner in order to, e.g., avoid any alterations of the lamination result by stopping any pressure onto the laminated functional foil. Additionally, the pressure adjustment may further simplify the unclamping step by moving the thermal forming module away from the foil holder, wherein, e.g., no sudden pressure equalization occurs when the clamping is opened.

The method may comprise stopping the application of the vacuum when the setting temperature is reached. Stopping the application of the vacuum may comprise decompressing the inside of the foil holder (and/or letting air into the inside the foil holder, e.g., until the atmospheric pressure is reached. Advantageously, the thermoforming process can be performed and ended in a more controlled manner in order to, e.g., reduce any additional stresses to the functional, until the setting temperature is reached, at which the functional foil is cooled off to the finished shape without permitting any further stretching.

The method may comprise ending (and/or opening) the clamping of the placed functional foil between the foil holder and the thermal forming module by moving the thermal forming module away from the foil holder, when the application of the vacuum has been stopped. The clamping may be ended when the atmospheric pressure is reached above and below the functional foil and/or when the atmospheric pressure is reached inside the foil holder and optionally inside the thermal chamber. Advantageously, the clamping can be opened and the finished laminated optical element can be retrieved in an easy manner, wherein, as stated above, no additional clamping components are necessary for fixing the functional foil at an intended position. Accordingly, no additional clamping components have to be opened and/or removed for retrieving the finished laminated optical element. As stated above, the pressure adjustment may further simplify the unclamping (by moving the thermal forming module away from the foil holder), wherein, e.g., no sudden pressure equalization occurs when the clamping is opened.

The method may comprise removing the (laminated) optical element after the clamping has been ended (and/or opened). Advantageously, the finished product, i.e., the laminated optical element, is provided at the end of the described method by simply removing it from the laminating device.

The method being suitable for manufacturing a spectacle lens may further comprise adapting the spectacle lens for insertion into a spectacle frame, wherein the adapting the spectacle lens for insertion into the spectacle frame is carried out before or after laminating the functional foil onto the surface of the optical element.

The method may be adapted to manufacture a spectacle lens for stock, i.e., a spectacle lens not manufactured in response to a specific demand with individual refractive values, but having prescription values being often sought after. Such spectacle lenses made for stock may then be supplied out of the stock for a customer requesting a spectacle lens witch such prescription values. The applied lamination on at least one surface of the spectacle lens and optionally on both surfaces of the spectacle lens may protect the spectacle lens from ingress and contamination. The spectacle lens may be provided as a finished spectacle lens product in an uncut manner, without prior edging. The at least one surface may include a front surface and/or a back surface of the spectacle lens.

The method may be adapted to individually manufacture a spectacle lens for being inserted in a specified spectacle frame. The spectacle lens may be edged to fit the dimensions of the spectacle frame.

The functional foil may be made from a single layer or laminated layers of cellulose triacetate, polyethylene terephthalate, polycarbonate, polyvinyl alcohol, cyclic olefin polymer and/or cyclic olefin copolymer. Advantageously, the listed materials can be thermoformed while, e.g., minimizing or avoiding any misshaping and/or shrinkage, which is particularly beneficial for achieving the desired curvature of the functional foil during the thermoforming.

What is described herein with respect to the laminating device applies analogously to the method and vice versa.

It is understood by a person skilled in the art that the above-described features and the features in the following description and drawings are not only disclosed in the exemplary embodiments and combinations, but that also other technically feasible combinations as well as the isolated features are comprised by the disclosure. In the following, several exemplary embodiments and specific examples are described with reference to the drawings for illustrating the disclosure without limiting the disclosure to the exemplary embodiments.

### BRIEF DESCRIPTION OF THE DRAWINGS

The disclosure will now be described with reference to the drawings wherein:

FIG. 1 shows a schematic cross-sectional view of a laminating device according to an exemplary embodiment of the disclosure, including a functional foil and an optical element held by the laminating device;

FIG. 2 shows another schematic cross-sectional view of the laminating device, excluding the functional foil and the optical element;

FIG. 3 shows a schematic flow diagram of a method according to an exemplary embodiment of the disclosure; and

FIGS. 4 and 5 show schematically principle steps of the method with a surface that is to be laminated of the optical element having a concave or convex form; and

FIG. 6: schematically depicts a method suitable for manufacturing a spectacle lens.

### DETAILED DESCRIPTION OF EXEMPLARY EMBODIMENTS

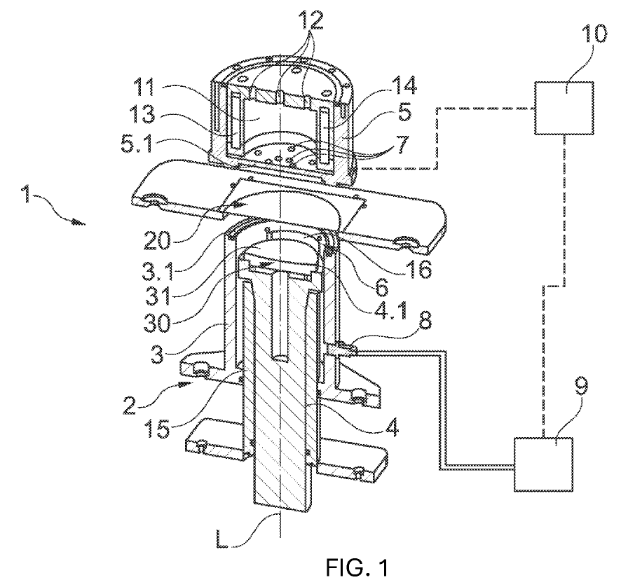

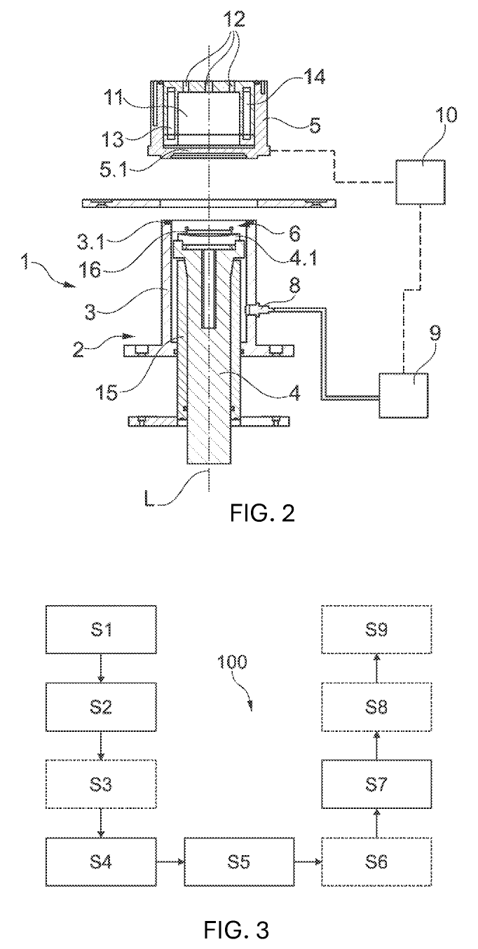

FIGS. 1 and 2 show schematic cross-sectional views of the laminating device 1 for laminating a functional foil 20 onto a surface 31 of an optical element 30 according to an exemplary embodiment of the disclosure. The optical element 30 may be a spectacle lens, a lens blank, a semi-finished spectacle lens product, or a finished spectacle lens product. The laminating device 1 comprises a holding module 2 and a thermal forming module 5.

The holding module 2 comprises a sleeve-shaped foil holder 3 extending along a central longitudinal axis L and having an opening 6 at an upper longitudinal end 3.1 of the foil holder 3, wherein the upper longitudinal end 3.1 is configured to hold the functional foil 20.

The holding module 2 further comprises an optical element holder 4 for holding the optical element 30, wherein the foil holder 3 surrounds the optical element holder 4. In other words, the optical element holder 4 is arranged inside a cavity of the foil holder 3, wherein the cavity is open on the upper side by the opening 6 at the upper longitudinal end 3.1. Accordingly, the foil holder 3 is configured to hold the functional foil 20 and the optical element holder 4 is configured to hold the optical element 30 such that the optical element 30 is arranged at a distance below the functional foil 20 with the surface 31 of the optical element 30 facing the functional foil 20.

The optical element holder 4 may be is movable along the central longitudinal axis L at an adjustable velocity inside the foil holder 3. The holding module 2 and the thermal forming module 5 are arranged along the central longitudinal axis L such that the lower longitudinal end 5.1 of the thermal forming module 5 and the upper longitudinal end 3.1 of the foil holder 3 are facing each other.

The thermal forming module 5 is movable along the central longitudinal axis L for adjusting a distance between the lower longitudinal end 5.1 of the thermal forming module 5 and the upper longitudinal end 3.1 of the foil holder 3.

The thermal forming module 5 comprises at least one air passage 7 for providing an air flow with a controlled temperature and a controlled pressure, wherein the at least one air passage 7 is arranged at a lower longitudinal end 5.1 of the thermal forming module 5. The thermal forming module 5 and/or the at least one air passage 7 can be configured to provide the air flow directed downwards along the central longitudinal axis L, in particular directed towards the opening 6 at the upper longitudinal end 3.1 of the foil holder 3.

The foil holder 3 comprises at least one vacuum passage 8. The laminating device 1 comprises a vacuum pump 9 connected to the at least one vacuum passage 8 for applying a vacuum inside the foil holder 3.

The laminating device 1 may comprise a control unit 10 for controlling the thermal forming module 5 and the vacuum pump 9. In an operating state of the laminating device 1, the control unit 10 may be configured to control the thermal forming module 5 to provide the air flow with the control temperature and pressure, and to simultaneously activate the vacuum pump 9 and/or control the vacuum pump 9 to apply a vacuum inside the foil holder 3.

The holding module 2 may comprise a guiding element 15 for guiding the optical element holder 4 inside the foil holder 3, i.e., inside the cavity of the foil holder 3. The guiding element 15 may be sleeved-shaped and extending along the central longitudinal axis L, wherein the optical element holder 4 may be partially arranged (and moveably arranged) inside the guiding element 15.

An upper longitudinal end 4.1 of the optical element holder 4 may be configured to hold the optical element 30 in such a way that the surface 31 of the optical element 30 is arranged averted from the upper longitudinal end 4.1 of the optical element holder 4 and/or facing the opening 6 of the foil holder 3.

The upper longitudinal end 3.1 of the foil holder 3 may be configured to hold the functional foil 20 such that a portion of the functional foil 20 to be laminated onto the surface 31 of the optical element 30 is arranged above the opening 6 and/or the opening 6 is closed by the functional foil 20.

The thermal forming module 5 may be movable along the central longitudinal axis L for clamping the functional foil 20 between the lower longitudinal end 5.1 of the thermal forming module 5 and the upper longitudinal end 3.1 of the foil holder 3 in an operating state of the laminating device 1.

The thermal forming module 5 may further comprise a thermal chamber 11 which is fluidly connected to the at least one air passage 7, and at least one air inlet 12 for providing air to the thermal chamber 11. The thermal forming module 5 may further comprise a heating element 13 arranged inside the thermal chamber 11, wherein the heating element 13 may be configured to heat the air provided by the at least one air inlet 12 to reach the controlled temperature. The control unit 10 may be configured to control the heating element 13.

It is also possible that the thermal forming module 5 may further comprise a thermocouple 14 arranged inside the thermal chamber 11, wherein the thermocouple 14 may be configured to measure the temperature of the air heated by the heating element, in order to the determine when the air has reached the controlled temperature.

The thermal forming module 5 may further comprise a cooling unit, which is not shown in the figure, for providing a controlled cooling process and/or for cooling the air flow to reach the controlled temperature.

The thermal forming module may further comprise a pressure unit, which is not shown in the figure, for providing the air flow with the controlled pressure. The pressure unit may be arranged inside the thermal chamber 11 and/or the at least one air passage 7. Alternatively, or in addition, the laminating device 1 may comprise an air pressure unit (not shown) (e.g., an air pump) for providing air with the controlled pressure, wherein the air pressure unit may be fluidly connected to the thermal forming module 5¸ e.g., the at least one air inlet 12 for providing the air (e.g., the air flow) with the controlled pressure into the thermal chamber 11. The control unit 10 may be configured to control the pressure unit and/or the air pressure unit.

The foil holder 3 may comprise a window 16 for observing the optical element 30 and/or the functional foil 12. The window 16 may be arranged adjacent to the upper longitudinal end 3.1 of the foil holder 3.

FIG. 3 illustrates a method 100 for laminating a functional foil 20 onto a surface 31 of an optical element 30, optionally using the laminating device 1.

In a first step S1, the optical element 30 is placed on the optical element holder 4 of the laminating device 1, e.g., through the opening 6.

In a second step S2, the functional foil 20 is placed on the foil holder 3 of the laminating device 1. In the steps S1 and S2 the functional foil 20 and the optical element 30 are placed such that the optical element 30 is arranged at a distance below the functional foil 20 with the surface 31 of the optical element 30 facing the functional foil 20.

The functional foil 20 may be made from a single layer or laminated layers of cellulose triacetate, polyethylene terephthalate, polycarbonate, polyvinyl alcohol, cyclic olefin polymer and/or cyclic olefin copolymer.

The functional foil may comprise a pressure sensitive adhesive coated on one side of the functional foil, wherein the functional foil 20 may be placed on the foil holder 3 with the side of the functional foil facing the surface 31 of the optical element 30.

In an optional third step S3, the placed functional foil 20 may be clamped between the foil holder 3 and a thermal forming module 5 of the laminating device 1 by moving the thermal forming module 5 towards the foil holder 3.

In a fourth step S4, an air flow is provided with a controlled temperature and pressure above the placed functional foil 20. The controlled temperature may correspond to a glass transition temperature of the functional foil 20 or higher.

In a fifth step S5, a vacuum is applied below the placed functional foil 20 simultaneously to providing the air flow.

In an optional sixth step S6, the controlled pressure of the air flow may be is adjusted and/or temporarily increased before the functional foil 20 is arranged onto the surface 31 of the optical element 30, until the functional foil is stretched into a spherical shape with a radius that is 40mm to 80mm smaller than a radius of a center area of the optical element 30. The functional foil may be stretched such that the radius of the spherical shape may be in a range from 40mm to 80mm.

In a seventh step S7, the functional foil 20 is arranged onto the surface 31 of the optical element 30 while the air flow is provided and the vacuum is applied. In order to do so, the optical element 30 may be moved upwards towards the functional foil 20 at an adjustable velocity by moving the optical element holder 4, until, at first, a central area of the optical element 30 touches the bent functional foil 20, and then the functional foil 20 is arranged onto the surface 31. For instance, the optical element 30 may be moved, until the surface 31 is positioned at or inside the opening 6.

In an optional eighth step S8, the controlled temperature may be reduced to a setting temperature of the functional foil 20 after the functional foil 20 is arranged onto the surface 31 of the optical element 30.

In an optional ninth step S9, the application of the vacuum may be stopped when the setting temperature is reached, e.g., by decompressing the inside of the foil holder 3. Additionally, the air flow may be stopped or the controlled pressure may be set to the atmospheric pressure.

Then, the clamping of the placed functional foil 20 between the foil holder 3 and the thermal forming module 5 may be ended by moving the thermal forming module 5 away from the foil holder 3, e.g., when the atmospheric pressure is reached above and below the functional foil 20 and/or when the atmospheric pressure is reached inside the foil holder 3 and inside the thermal chamber 11.

Finally, the laminated optical element 30 may be removed from the laminating device 1, e.g., through the opening 6.

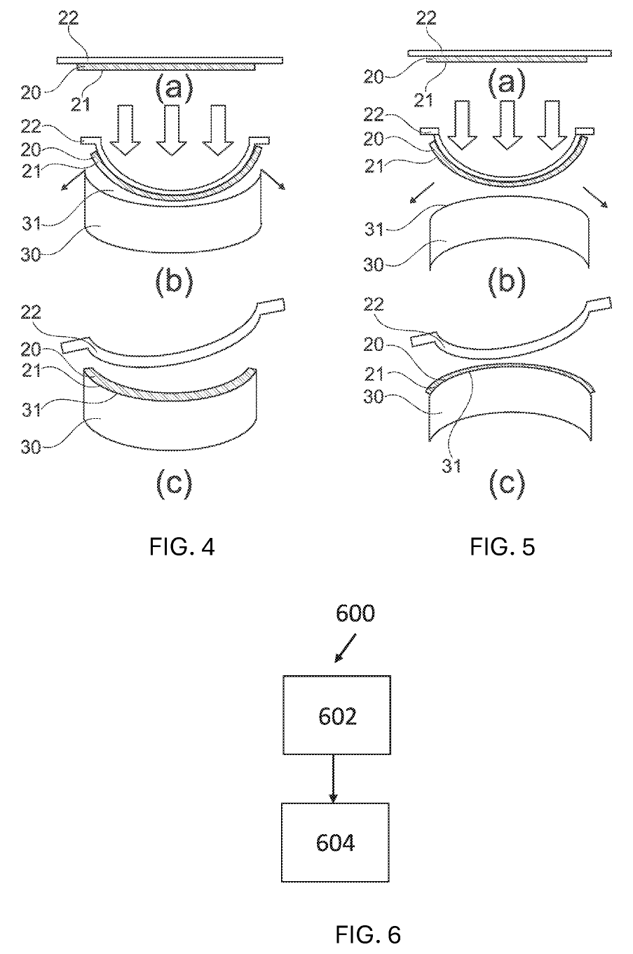

FIG. 4 illustrates the principle steps of the method 100, wherein the surface 31 of the optical element 30 has a concave form.

In FIG. 4, panel (a), the functional foil 20 is shown, wherein the functional foil 20 comprises a pressure sensitive adhesive 21 coated on one side of the functional foil 20. Additionally, the functional foil 20 is arranged on a release film 22, wherein the release film 22 is arranged at a second side of the functional foil 20 opposite to the pressure sensitive adhesive 21. Alternatively, or in addition, to the pressure sensitive adhesive 21, the functional foil 20 may comprise an optical glue.

The functional foil is placed on the foil holder 3 with the side of the functional foil 20 with the pressure sensitive adhesive 21 facing the surface 31 of the optical element 31, and with the second side of the functional foil 20 and thus the release film 22 averted from the optical element 30.

FIG. 4, panel (b) shows that the air flow (illustrated by the three arrows pointing downwards) is provided with a controlled temperature and pressure above the placed foil holder 3 towards the functional foil 20. Due to the air flow, the functional foil 20 is stretched and/or bent into a spherical shape, until a desired curvature of the functional foil 20 is achieved. The desired curvature may comprise a radius that is (e.g., 40mm to 80mm) smaller than a radius of a center area of the optical element 30.

Simultaneously to providing the air flow above the functional foil 20, a vacuum is applied below the functional foil 20, such as between the functional foil 20 and the optical element 30, resulting in a vacuum or at least a negative air pressure in the area between the functional foil 20 and the optical element 30 (illustrated by the two arrows arranged left and right to the optical element 30). The vacuum prevents air traps between the functional foil 20 and the optical element 30 and provides a uniform bending force.

The functional foil 20 is arranged onto the surface 31 of the optical element 30 while the air flow is provided and the vacuum is applied, wherein the pressure sensitive adhesive is pressed onto the surface 31 so as to maintain the functional foil 20 on the surface 31.

FIG. 4, panel (c) shows that the release film 22 is removed from the functional foil 20, after the functional foil 20 has been arranged and laminated onto the surface 31.

FIG. 5, panels (a) through (c), shows another illustration of the principle steps of the method 100, which are substantially the same as in FIG. 4, with the only difference that the surface 31 of the optical element 30 has a different form, namely a convex form.

The forms of the surface 31 shown in FIGS. 4 and 5 are merely exemplary, as the method 100 may be performed for any free-form surface 31. In other words, the method 100 and the laminating device 1 may be used for laminating functional foils on surfaces having any form and are not limited to convex or concave surfaces.

FIG. 6 schematically depicts a method 600 being suitable for manufacturing a spectacle lens.

The method 600 comprises laminating 602 a functional foil 20 onto a surface 31 of an optical element 30 using a method 100 according to the disclosure, wherein the optical element 30 is the spectacle lens to be manufactured or one of a lens blank, a semi-finished lens blank or an uncut finished lens from which the spectacle lens is manufactured.

The method may further comprise adapting 604 the spectacle lens for insertion into a spectacle frame, wherein the adapting 604 the spectacle lens for insertion into the spectacle frame is carried out before or after laminating 602 the functional foil onto the surface of the optical element.

The foregoing description of the exemplary embodiments of the disclosure illustrates and describes the present invention. Additionally, the disclosure shows and describes only the exemplary embodiments but, as mentioned above, it is to be understood that the disclosure is capable of use in various other combinations, modifications, and environments and is capable of changes or modifications within the scope of the concept as expressed herein, commensurate with the above teachings and/or the skill or knowledge of the relevant art.

The term “comprising” (and its grammatical variations) as used herein is used in the inclusive sense of “having” or “including” and not in the exclusive sense of “consisting only of.” The terms “a” and “the” as used herein are understood to encompass the plural as well as the singular.

All publications, patents and patent applications cited in this specification are herein incorporated by reference, and for any and all purposes, as if each individual publication, patent or patent application were specifically and individually indicated to be incorporated by reference. In the case of inconsistencies, the present disclosure will prevail.

### LIST OF REFERENCE SIGNS

1 laminating device

2 holding module

3 foil holder

3.1 upper longitudinal end of the foil holder

4 optical element holder

4.1 upper longitudinal end of the optical element holder

5 thermal forming module

5.1 lower longitudinal end of the thermal forming module

6 opening

7 air passages

8 vacuum passage

9 vacuum pump

10 control unit

11 thermal chamber

12 air inlets

13 heating element

14 thermocouple

15 guiding element

16 window

20 functional foil

21 pressure sensitive adhesive

22 release film

30 optical element/spectacle lens

31 surface of the optical element

L central longitudinal axis

100 method

S1-S9 method steps

600 method suitable for manufacturing a spectacle lens

602-604 method steps

1. A laminating device for laminating a functional foil onto a surface of an optical element, the laminating device comprising:
a holding module which contains:
a sleeve-shaped foil holder extending along a central longitudinal axis and having an opening at an upper longitudinal end of the foil holder, wherein the upper longitudinal end is configured to hold the functional foil; and
an optical element holder for holding the optical element, wherein the foil holder surrounds the optical element holder; and
a thermal forming module which contains at least one air passage for providing an air flow with a controlled temperature and pressure, wherein the at least one air passage is arranged at a lower longitudinal end of the thermal forming module,
wherein the holding module and the thermal forming module are arranged along the central longitudinal axis, such that the lower longitudinal end of the thermal forming module and the upper longitudinal end of the foil holder are facing each other,
wherein the thermal forming module is movable along the central longitudinal axis for adjusting a distance between the lower longitudinal end of the thermal forming module and the upper longitudinal end of the foil holder, and
wherein
the foil holder comprises at least one vacuum passage;
the laminating device comprises a vacuum pump connected to the at least one vacuum passage for applying a vacuum inside the foil holder; and
the optical element holder is movable along the central longitudinal axis at an adjustable velocity inside the foil holder.

2. The laminating device according to claim 1, the laminating device further comprising:
a control unit for controlling the thermal forming module and the vacuum pump, wherein, in an operating state of the laminating device, the control unit is configured to control the thermal forming module to provide the air flow with the control temperature and pressure, and to simultaneously activate the vacuum pump and/or control the vacuum pump to apply a vacuum inside the foil holder.

3. The laminating device according to claim 1, wherein the upper longitudinal end of the optical element holder is configured to hold the optical element such that the surface of the optical element is arranged averted from the upper longitudinal end of the optical element holder and/or facing the opening of the foil holder.

4. The laminating device according to claim 1, wherein the upper longitudinal end of the foil holder is configured to hold the functional foil such that a portion of the functional foil to be laminated onto the surface of the optical element is arranged above the opening and/or the opening is closed by the functional foil.

5. The laminating device according to claim 1, wherein the thermal forming module is movable along the central longitudinal axis for clamping the functional foil between the lower longitudinal end of the thermal forming module and the upper longitudinal end of the foil holder in an operating state of the laminating device.

6. The laminating device according to claim 1, wherein the thermal forming module further comprises:
a thermal chamber which is fluidly connected to the at least one air passage;
at least one air inlet for providing air to the thermal chamber; and
a heating element arranged inside the thermal chamber, wherein the heating element is configured to heat the air provided by the at least one air inlet to reach the controlled temperature.

7. The laminating device according to claim 1, wherein the thermal forming module further comprises:
a cooling unit for providing a controlled cooling process and/or for a cooling of the air flow to reach the controlled temperature.

8. A method for laminating a functional foil onto a surface of an optical element, the method comprising:
placing the optical element on an optical element holder of a laminating device;
placing the functional foil on a foil holder of the laminating device, wherein the functional foil and the optical element are placed such that the optical element is arranged at a distance below the functional foil with the surface of the optical element facing the functional foil;
providing an air flow with a controlled temperature and pressure above the placed functional foil;
applying a vacuum below the placed functional foil simultaneously to providing the air flow; and
arranging the functional foil onto the surface of the optical element while the air flow is provided and the vacuum is applied,
wherein the method further comprises:
adjusting and/or temporarily increasing the controlled pressure of the air flow before the functional foil is arranged onto the surface of the optical element, until the functional foil is stretched into a spherical shape with a radius that is smaller than a radius of a center area of the optical element.

9. The method according to claim 8, wherein the radius of the spherical shape of the stretched functional foil is in a range from 40 mm to 80 mm.

10. The method according to claim 8, wherein
the functional foil includes a pressure sensitive adhesive and/or an optical glue coated on one side of the functional foil, wherein the functional foil is placed on the foil holder with the side of the functional foil facing the surface of the optical element, and/or
the optical element includes a pressure sensitive adhesive and/or an optical glue coated on the surface of the optical element.

11. The method according to claim 8, wherein the method comprises:
clamping the placed functional foil between the foil holder and the thermal forming module of the laminating device by moving the thermal forming module towards the foil holder.

12. The method according to claim 8, wherein the controlled temperature corresponds to a glass transition temperature of the functional foil or higher.

13. The method according to claim 8, the method further comprising:
reducing the controlled temperature to a setting temperature of the functional foil after the functional foil is arranged onto the surface of the optical element; and
stopping the application of the vacuum when the setting temperature is reached.

14. The method according to claim 8, wherein the functional foil is made from a single layer or laminated layers of cellulose triacetate, polyethylene terephthalate, polycarbonate, polyvinyl alcohol, cyclic olefin polymer, and/or cyclic olefin copolymer.

15. The method according to claim 8, wherein the optical element is a spectacle lens or a lens blank or a semi-finished spectacle lens product or a finished spectacle lens product.

16. A method being suitable for manufacturing a spectacle lens, the method comprising:
laminating a functional foil onto a surface of an optical element using the method according to claim 8, wherein the optical element is the spectacle lens to be manufactured or one of a lens blank, a semi-finished lens blank, or an uncut finished lens from which the spectacle lens is manufactured.

17. The method according to claim 16, further comprising:
adapting the spectacle lens for insertion into a spectacle frame, wherein the adapting the spectacle lens for insertion into the spectacle frame is carried out before or after laminating the functional foil onto the surface of the optical element.
